(19) United States
(12) Patent Application Publication
(10) Pub. No.: US 2006/0153015 A1
(43) Pub. Date: Jul. 13, 2006

(54) CD-ROM based optical biosensors

(76) Inventors: Vitaly J. Vodyanoy, Auburn, AL (US); Alexei Samoylov, Urbana, IL (US); Timothy E. Moore, Jacksonville, AL (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/149,869

(22) Filed: Jun. 10, 2005

Related U.S. Application Data
(60) Provisional application No. 60/579,117, filed on Jun. 12, 2004.

(51) Int. Cl. G11B 7/00

(52) U.S. Cl. 369/30.01; 369/44.27

(57) ABSTRACT

A CD-ROM based optical biosensor, system and method of sensing biological samples in the air includes treating the surface of a CD-ROM medium with a receptor capable of binding with a targeted biological sample. While continuous reading of the CD-ROM is conducted by a CD-ROM drive, an air-flow is directed through the CD-ROM drive, over and around the CD-ROM such that any targeted biological samples present in the air will bind with the receptors. The laser reader of the CD-ROM device detects these biological samples as they obstruct the data blocks present on the CD-ROM. A processor of the CD-ROM drive determines whether an output signal is required, and if so, appropriately sends one to an output device.

### CROSS REFERENCE TO RELATED APPLICATION

This application claims priority under 35 U.S.C. §119(e) of the co-pending U.S. Provisional Patent Application, Serial No. 60/579,117, filed Jun. 12, 2004, and entitled “CD-ROM BASED OPTICAL BIOSENSORS”. The U.S. Provisional Patent Application, Serial No. 60/579,117, filed Jun. 12, 2004, and entitled “CD-ROM BASED OPTICAL BIOSENSORS” is also hereby incorporated by reference.

### FIELD OF THE INVENTION

The invention relates to the field of biosensing. More particularly, the invention relates to the field of utilizing CD-ROM based technology to sense biological samples in the air.

### BACKGROUND OF THE INVENTION

Optical biosensors are devices in which a biological sensing element is coupled to an optical recognition system. Such systems must be sensitive enough to differentiate between minute changes in optical properties of the sensing media, as well as interpret these changes.

Optical biosensors are oftentimes utilized as indicators to show when unsafe biological samples are present in the air. Another problem associated with current optical biosensors is the lack of capability to continuously monitor the surrounding air, while having the ability to instantly notify a user of the optical biosensor of the presence of the targeted biological samples in the air.

### SUMMARY OF THE INVENTION

A CD-ROM based optical biosensor, system and method of sensing biological samples in the air includes treating the surface of a CD-ROM medium with a receptor capable of binding with a targeted biological sample. While continuous reading of the CD-ROM is conducted by a CD-ROM drive, an air-flow is directed through the CD-ROM drive, over and around the CD-ROM such that any targeted biological samples present in the air will bind with the receptors. The laser reader of the CD-ROM device detects these biological samples as they obstruct the data blocks present on the CD-ROM. A processor of the CD-ROM drive determines whether an output signal is required, and if so, appropriately sends one to an output device.

An optical biosensor for detecting a targeted biological sample in air comprising a CD-ROM, the CD-ROM including a plurality of data blocks raised from the surface of the CD-ROM, the plurality of data blocks configured spirally around the center of the CD-ROM, a receptor medium, configured to coat the surface of the CD-ROM such that the receptor medium binds with the targeted biological sample, and a reader, configured to read the plurality of data blocks of the CD-ROM, and further configured to detect the targeted biological sample when the targeted biological sample binds with the receptor medium, wherein the targeted biological sample obstructs the reader from reading the plurality of data blocks, further wherein the reader is configured to output a recognizable signal. The optical biosensor further comprising a processor configured to receive the recognizable signal and determine whether an output signal is transmitted to an output device, wherein the output device is a graphical user interface, the output device is an audible alarm device, and the output device is a visual alarm device. The optical biosensor further comprising a set of computer code embedded on the processor, wherein the computer code facilitates the processing of the recognizable signal, the CD-ROM is segmented such that each of a plurality of segments is treated with a distinct form of the receptor medium, such that each segment is configured to bind a distinct form of the targeted biological sample, and the receptor medium is configured to bind with a targeted chemical compound.

A system for detecting a targeted biological sample in air comprising a CD-ROM coated with a receptor medium such that the receptor medium binds with the targeted biological sample, a CD-ROM drive configured to continuously read the CD-ROM, the CD-ROM drive including an air flow path configured to continuously sample the air and channel the air over and around the CD-ROM, a reader configured to read a plurality of data blocks of the CD-ROM, and further configured to detect the targeted biological sample when the targeted biological sample binds with the receptor medium, wherein the targeted biological sample obstructs the reader from the plurality of data blocks, and a processor configured to receive a recognizable signal from the reader, and an output device coupled to the CD-ROM device and configured to receive an output signal from the processor. The system wherein the output device is a graphical user interface, the output device is an audible alarm device, and the output device is a visual alarm device. The system further comprising a set of computer code embedded on the processor, wherein the computer code facilitates the processing of the recognizable signal, the CD-ROM is segmented such that each of a plurality of segments is treated with a distinct form of the receptor medium, such that each segment is configured to bind a distinct form of the targeted biological sample, and the receptor medium is configured to bind with a targeted chemical compound.

A method of sensing a targeted biological sample comprising applying a receptor medium to a CD-ROM, continuously reading the CD-ROM with a CD-ROM drive, directing an air flow through the CD-ROM drive, reading a biological signal produced by binding of any of the targeted biological samples present in the air and the receptor medium, thus creating a biological signal, converting the biological signal to a recognizable signal, processing the recognizable signal, and sending an output signal corresponding to the recognizable signal. The method wherein the output signal is received by an output device, the output device is a graphical user interface, the output device is an audible alarm device, and the output device is a visual alarm device. The method further comprising segmenting the CD-ROM such that each of a plurality of segments is treated with a distinct form of the receptor medium, such that each segment is configured to bind a distinct form of the targeted biological sample, wherein the receptor medium is configured to bind with a targeted chemical compound.

### BRIEF DESCRIPTION OF THE DRAWINGS

FIGS. 1a-1c illustrate a block diagram of an optical biosensor, with accompanying reader and processor.

FIGS. 2a-2b illustrate a graphical representation of a CD-ROM biosensor.

FIG. 2c is a block diagram illustrating a CD-ROM biosensor system.

FIG. 3 illustrates a flow chart illustrating a biosensing method.

### DETAILED DESCRIPTION OF THE INVENTION

Δ CD-ROM based biosensor allows for a high level of integration with existing technologies while providing a very robust and sensitive platform for the detection of biological agents. An embodiment will attach specific biological agents such as, but not limited to, recognition antibodies or phages to the surface of a CD-ROM disc, and then direct collected air samples onto the surface. Binding and recognition will occur with the use of existing CD-ROM laser reader technology. Specially designed software algorithms embedded in the processor of the CD-ROM drive will promote accurate and rapid detection, and counter the random accessing design of the CD-ROM readers. This architecture is inexpensive to replicate, and provides robust and rapid detection of biological threats in a hand-held or mounted device.

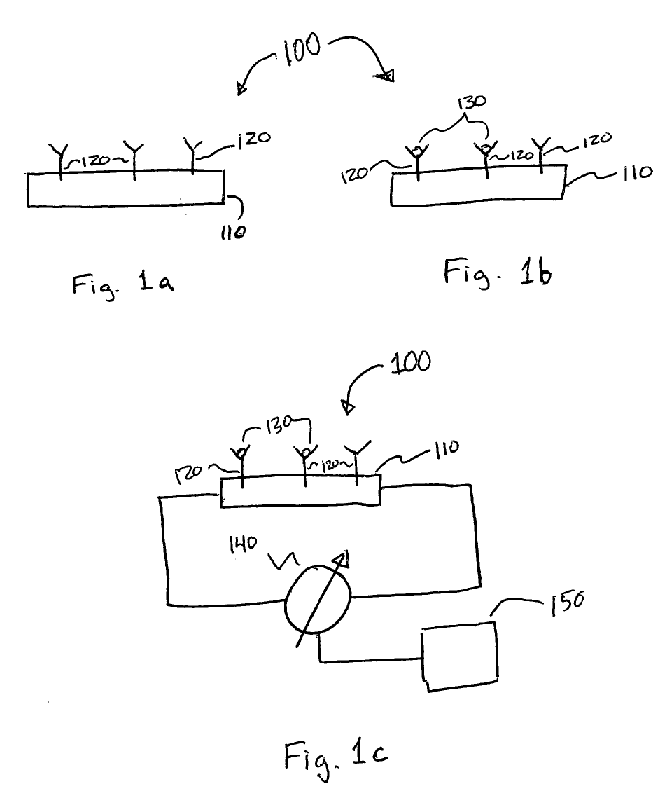

FIGS. 1a-1c illustrate an optical biosensor 100. In FIG. 1a, an optical biosensor 100 includes a number of receptors 120 coupled to a transducer 110. The receptor 120 is a recognition unit or element that targets a natural biological sample 130 or an artificial sample for binding. The receptor 120 may be an antibody, peptide, phage, or any receptor known in the art. The receptor 120 is configured to bind the targeted biological sample 130.

FIG. 1c illustrates how the optical biosensor 100 utilizes a number of receptors 120 to bind with biological samples 130. It should be noted that the transducer 110, which can be a quartz crystal, or any other transducer known in the art, has an oscillating frequency (ωₒ), which is altered by a frequency shift (Δω) when a biological sample 130 binds with the receptor 120. This frequency shift (Δω) creates a biological signal, that is converted into a recognizable signal by the transducer 110. A recognizable signal is an appropriate signal for the current system that the optical biosensor is operating under. For example, the recognizable signal may include, but is not limited to, electrical signals, infrared signals, or optical signals. Once a recognizable signal is created, the reader 140 interprets this signal and passes it on to the processor 150, where the processor 150 determines whether an output is required in response to the particular biological samples 130 collected.

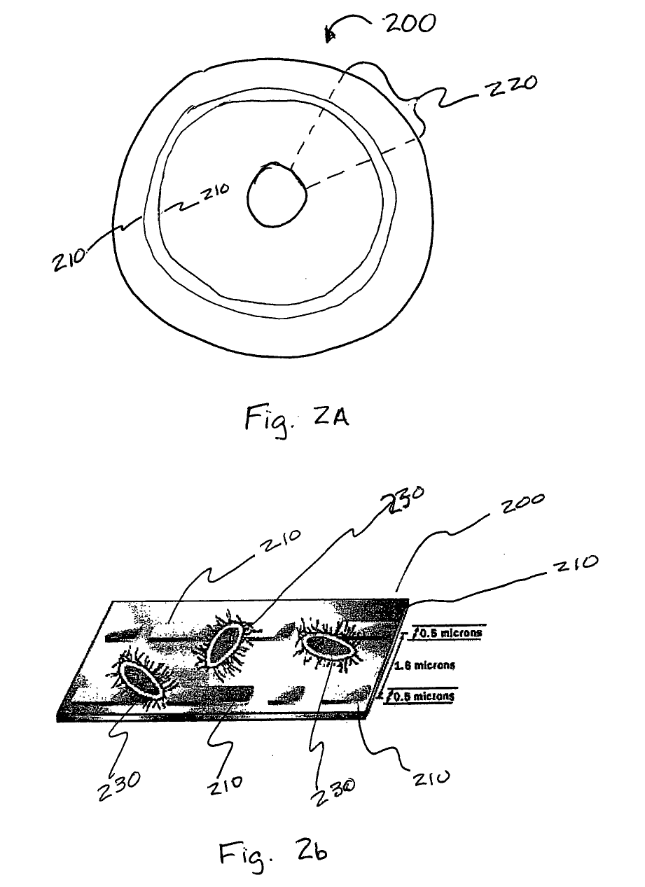

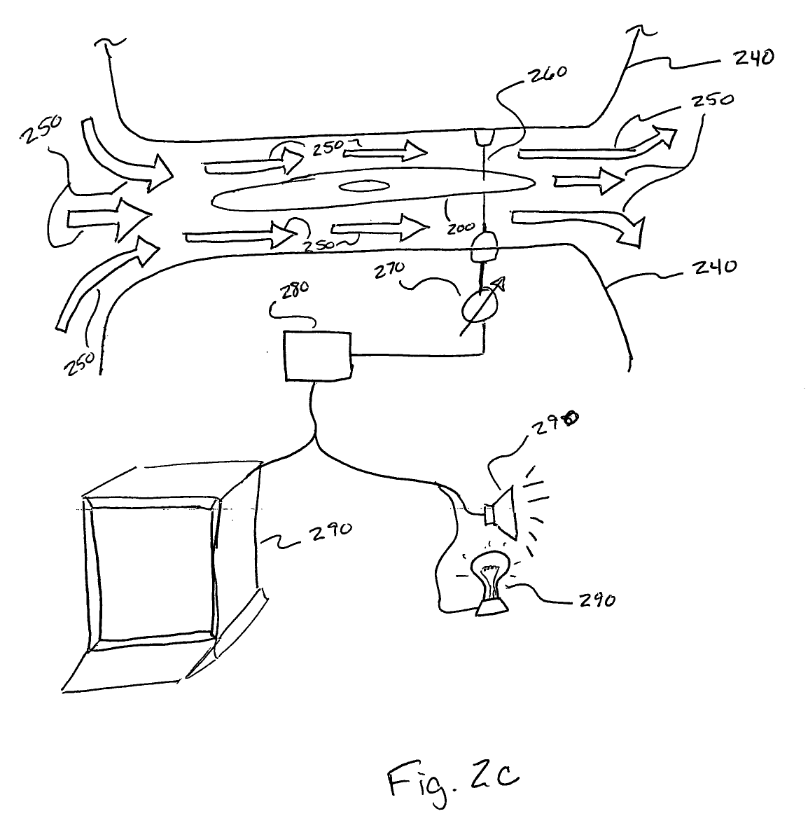

FIG. 2a illustrates a CD-ROM biosensor 200. The CD-ROM biosensor 200 utilizes a current CD-ROM format, including the data blocks 210 that include the “1s” and “0s” that is the data that is being stored on the CD-ROM. As is well known in the art, a CD-ROM drive utilizes a laser to read the data blocks 210 on the CD-ROM. The CD-ROM biosensor 200 is treated with a receptor material as is described previously in the discussion of FIGS. 1a-1c, such that the targeted biological samples in the air are then configured to bind with the CD-ROM biosensor 200. Once again, the receptors applied to the surface of the CD-ROM biosensor 200 can be any of antibodies, peptides, or phages, or any other binding receptor known in the art. It is also contemplated that such a CD-ROM biosensor 200 may be treated for various biological samples by treating sectors 220 with different receptors targeting different and separate biological samples.

FIG. 2b is a magnified illustration of the CD-ROM biosensor 200 of FIG. 2a. In FIG. 2b, the data blocks 210 are shown to be preferably 0.5 microns wide and 1.6 microns apart, from center to center. The length of the data blocks 210 is dependent upon whether that particular data block is a “1” or a “0”. Once again, the CD-ROM biosensor 200 in FIG. 2b is treated with a binding receptor that is capable of binding with biological samples 230 as shown. When such biological samples 230 bind with the receptors applied to the CD-ROM biosensor 200, the laser reading CD-ROM drive will detect the biological samples 230 and produce a recognizable signal, such that the processor of the CD-ROM drive will recognize the biological samples.

FIG. 2c illustrates a CD-ROM biosensor system. Here, the CD-ROM biosensor 200 is configured in a CD-ROM drive 240, having a laser 260, a reader 270, and a processor 280. It should be noted that FIG. 2c is merely a block diagram, and that the details of the CD-ROM drive 240 have been omitted for the sake of simplicity. Of course, the CD-ROM biosensor 200 is secured in the CD-ROM drive 240 so as not to be floating in mid-air. Referring back to FIG. 2c, the CD-ROM biosensor 200 is coated with the desired binding receptor and continuously read by the CD-ROM drive 240. While the CD-ROM drive 240 is reading the CD-ROM biosensor 200 in a continuous manner, and airflow path 250 is created through the CD-ROM drive 240 such that the airflow path 250 is flowing over and around the CD-ROM biosensor 200. In this way, the receptors configured on the CD-ROM biosensor 200 will bind with any targeted biological samples present in the surrounding air that is directed through the air flow path 250. When a biological sample binds with the receptor on the CD-ROM biosensor 200, a recognizable signal will be sent by the laser 260 of the CD-ROM drive 240 to the reader 270 and passed on to the processor 280. The reader 270 converts the biological signal from the laser 260 into a signal recognizable by the processor 280.

Still referring to FIG. 2c, depending upon the system in which the CD-ROM biosensor 200 and CD-ROM drive 240 are implemented, the processor 280 may be configured to send an output signal to any of a number of output devices 290. For example, if the CD-ROM biosensor 200 is treated with a number of different receptors, a workstation output device 290 may be utilized to keep track of the various biological samples that are collected, along with their concentrations in the air. Such an output device 290 may include a graphical user interface in order to allow a user to analyze the data more efficiently. Also, the processor may output an alarm signal to either an audible alarm device or a lighted alarm device so that an individual in the same location as the CD-ROM biosensor 200 may be notified when a dangerous biological sample is present in the air.

The proposed method takes advantage of the inherent properties of the CD-ROM system to detect biological samples binding on the surface of the optical media (i.e. the CD-ROM disc). Preferably, the intensity of the reflected laser light is converted into a digital signal which can be processed by a specially designed application. Changes in the binary stream of the read data indicates binding of biological material to the surface at a specific location. To address the issues of CD-ROM safeguards such as noise cancellation, a simplified version of a standard CD-ROM drive must be built without such safeguards, data redundancy levels must be eliminated and a continuous spiral read of the CD-ROM must take place.

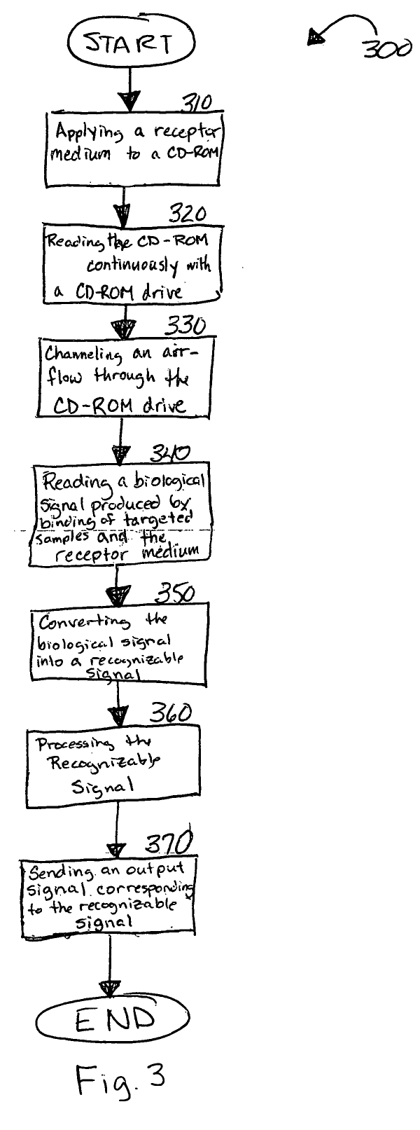

Referring to FIG. 3, a biosensing method is illustrated in a flow chart. In step 310, a receptor medium is applied to a CD-ROM. In step 320, the CD-ROM is continuously read with a CD-ROM drive. In step 330, an airflow is channeled through the CD-ROM drive, so that in step 340, any biological samples present in the airflow that bind with the receptor medium and produce a biological signal read.

In step 350, the biological signal is converted into a recognizable signal by the CD-ROM drive. In step 360, the recognizable signal is processed, and in step 370, an output is provided based on the recognizable signal to an output device.

There are many advantages to utilizing such a CD-ROM based biosensor including high sensitivity due to high resolution of the CD-ROM, an extraordinarily high number of biological sensors, high level of integration with existing technology, real-time or near real-time data processing and display, convenient data logging and data storage in digital format, and suitability for detection of a large variety of biological agents.

The present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications may be made in the embodiment chosen for illustration without departing from the spirit and scope of the invention.

I claim:

1. An optical biosensor for detecting a targeted biological sample in air, the optical biosensor comprising:
a.) a CD-ROM, the CD-ROM including a plurality of data blocks raised from the surface of the CD-ROM, the plurality of data blocks configured spirally around the center of the CD-ROM;
b.) a receptor medium, configured to coat the surface of the CD-ROM such that the receptor medium binds with the targeted biological sample; and
c.) a reader, configured to read the plurality of data blocks of the CD-ROM, and further configured to detect the targeted biological sample when the targeted biological sample binds with the receptor medium, wherein the targeted biological sample obstructs the reader from reading the plurality of data blocks, further wherein the reader is configured to output a recognizable signal.

2. The optical biosensor as claimed in claim 1, further comprising a processor configured to receive the recognizable signal and determine whether an output signal is transmitted to an output device.

3. The optical biosensor as claimed in claim 2, wherein the output device is a graphical user interface.

4. The optical biosensor as claimed in claim 2, wherein the output device is an audible alarm device.

5. The optical biosensor as claimed in claim 2, wherein the output device is a visual alarm device.

6. The optical biosensor as claimed in claim 2, further comprising a set of computer code embedded on the processor, wherein the computer code facilitates the processing of the recognizable signal.

7. The optical biosensor as claimed in claim 1, wherein the CD-ROM is segmented such that each of a plurality of segments is treated with a distinct form of the receptor medium, such that each segment is configured to bind a distinct form of the targeted biological sample.

8. The optical biosensor as claimed in claim 1, wherein the receptor medium is configured to bind with a targeted chemical compound.

9. A system for detecting a targeted biological sample in air, the system comprising:
a.) a CD-ROM coated with a receptor medium such that the receptor medium binds with the targeted biological sample;
b.) a CD-ROM drive configured to continuously read the CD-ROM, the CD-ROM drive including:
i.) an air flow path configured to continuously sample the air and channel the air over and around the CD-ROM;
ii) a reader configured to read a plurality of data blocks of the CD-ROM, and further configured to detect the targeted biological sample when the targeted biological sample binds with the receptor medium, wherein the targeted biological sample obstructs the reader from the plurality of data blocks; and
iii) a processor configured to receive a recognizable signal from the reader, and
c.) an output device coupled to the CD-ROM device and configured to receive an output signal from the processor.

10. The system as claimed in claim 9, wherein the output device is a graphical user interface.

11. The system as claimed in claim 9, wherein the output device is an audible alarm device.

12. The system as claimed in claim 9, wherein the output device is a visual alarm device.

13. The system as claimed in claim 9, further comprising a set of computer code embedded on the processor, wherein the computer code facilitates the processing of the recognizable signal.

14. The system as claimed in claim 9, wherein the CD-ROM is segmented such that each of a plurality of segments is treated with a distinct form of the receptor medium, such that each segment is configured to bind a distinct form of the targeted biological sample.

15. The system as claimed in claim 9, wherein the receptor medium is configured to bind with a targeted chemical compound.

16. A method of sensing a targeted biological sample, the method comprising:
a.) applying a receptor medium to a CD-ROM;
b.) continuously reading the CD-ROM with a CD-ROM drive;
c.) directing an air flow through the CD-ROM drive;
d.) reading a biological signal produced by binding of any of the targeted biological samples present in the air with the receptor medium, thus creating a biological signal;
e.) converting the biological signal to a recognizable signal;
f.) processing the recognizable signal; and
g.) sending an output signal corresponding to the recognizable signal.

17. The method as claimed in claim 16, wherein the output signal is received by an output device.

18. The method as claimed in claim 17, wherein the output device is a graphical user interface.

19. The method as claimed in claim 17, wherein the output device is an audible alarm device.

20. The method as claimed in claim 17, wherein the output device is a visual alarm device.

21. The method as claimed in claim 16, further comprising segmenting the CD-ROM such that each of a plurality of segments is treated with a distinct form of the receptor medium, such that each segment is configured to bind a distinct form of the targeted biological sample.

22. The method as claimed in claim 16, wherein the receptor medium is configured to bind with a targeted chemical compound.

23. A system for detecting a targeted biological sample in air, the system comprising a CD-ROM coated with a receptor medium such that the receptor medium binds with the targeted biological sample.

24. A method of sensing a targeted biological sample, the method comprising:
a.) applying a receptor medium to a CD-ROM; and
b.) reading a biological signal produced by binding of any of the targeted biological samples present in the air with the receptor medium, thus creating a biological signal.
